(19) United States
(12) Patent Application Publication
(10) Pub. No.: US 2017/0235357 A1
(43) Pub. Date: Aug. 17, 2017

(54) METHOD AND APPARATUS FOR POWER MANAGEMENT OF A REMOTE CLIENT DEVICE

(71) Applicant: Teradici Corporation, Burnaby (CA)

(72) Inventor: Alfred Hoi-Fai Leung, Coquitlam (CA)

(21) Appl. No.: 14/571,937

(22) Filed: Dec. 16, 2014

(51) Int. Cl. G06F 1/32; H04L 29/06

(52) U.S. Cl. CPC G06F 1/3212; H04L 67/42; G06F 1/3209; G06F 1/3234

(57) ABSTRACT

Embodiments of the present invention are directed towards a method and apparatus for managing power consumption of a client computer, comprising receiving, by a host computer from the client computer, a battery power management object (BPMO) related to a remote computing session, the host computer communicatively coupled to the client computer by the remote computing session and adjusting, by the host computer based on the battery power management object, at least one of i) at least one parameter associated with the remote computing session or ii) a source definition for the remote computing session.

### BACKGROUND OF THE INVENTION

Field of the Invention

Embodiments of the present invention relate generally to a method and apparatus for client power management in remote computing.

Description of the Related Art

Existing client devices based on ‘zero client’ processors are generally referred to as zero client devices, or zero clients. Zero clients are used in remote computing comprise real-time operating systems (RTOS) with generally limited set of power saving modes (e.g., ‘on’, ‘off’ and ‘standby’), rudimentary power management processes such as ‘wake on LAN’ (WoL), limited client status indication (e.g., a simple LED) and no in-session user feedback regarding the state of the client device itself. Furthermore, when compared to user-oriented configuration tools inherent to mature operating systems such as Microsoft Windows or Linux, configuration of such client devices requires use of low level tools with direct access to the client settings, a task generally delegated to skilled administrators.

There is a growing need to provide additional power saving modes for zero clients as they gain popularity in battery operated mobile applications and as System-on-Chip (SoC) technologies, which form the basis for zero client processors, become ever-more complex themselves. Furthermore, additional power savings functionality needs to better align with user experience objectives and improve on, rather than increase, the complexity related to configuration of devices incorporating zero client processors.

### SUMMARY OF THE INVENTION

Embodiments of the present invention generally relate to a method for managing power consumption of a zero client computer (client computer). In one embodiment, the method comprises receiving, by a host computer from the client computer, a battery power management object (BPMO) related to a remote computing session, the host computer communicatively coupled to the client computer by the remote computing session and adjusting, by the host computer based on the battery power management object, at least one of i) at least one parameter associated with the remote computing session or ii) a source definition for the remote computing session.

Embodiments of the present invention also relate to an apparatus for managing power consumption of a zero client computer (client computer). In this embodiment, the apparatus comprises a host computer communicatively coupled to a zero client computer via a remote desktop session that monitors capacity level of a battery of the zero client computer and adjusts parameters of the remote desktop session based on the capacity level.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates selected details of an embodiment of a system comprising a mobile zero client enabled to proxy power management information to a host computer;

FIG. 2 illustrates selected details of a host computer;

FIG. 3 illustrates selected details of a zero client processor;

FIG. 4(a) illustrates a zero client processor coupled to a wireless module by an SDIO connection;

FIG. 4(b) illustrates a zero client processor coupled to a wireless module by a PCIe connection;

FIG. 5 illustrates a zero client processor coupled to a wireless module by a USB connection;

FIG. 6 illustrates a zero client processor coupled to a wireless module by a UART;

FIG. 7 illustrates selected details of a set of power management objects;

FIG. 8 illustrates a flow diagram of a method for configuring a host computer based on a particular power profile;

FIG. 9 illustrates a flow diagram of a method for managing power-related settings of a client;

FIG. 10 illustrates a flow diagram of a method in which notification icons of a host computer convey dynamic information related to a mobile zero client;

FIG. 11 illustrates a flow diagram for a method in which the remote computing agent is configured to respond to the state of a mobile zero client;

FIG. 12 illustrates a flow diagram for a method in which a mobile zero client transitions between host-interactive operation and autonomous offline operation;

FIG. 13 illustrates a transition sequence in which a remote computing session is switched from a desktop client to a mobile zero client, and to a zero client projector;

FIG. 14 illustrates an initial connection process in which a session is transitioned from a desktop zero client to a mobile zero client;

FIG. 15 illustrates a subsequent connection process in which a session is transitioned from a desktop zero client to a mobile zero client;

FIG. 16 illustrates a flow diagram for a method in which a collaboration session is established between a mobile zero client and a zero client projector;

FIG. 17 illustrates a flow diagram for a method for adjusting protocol parameters or updating a source definition in response to a power management object received from a client; and

FIG. 18 illustrates a flow diagram for a method performed for adjusting a protocol parameter based on power consumption dynamics.

### DETAILED DESCRIPTION

The invention may be implemented in numerous ways, including as a process, an article of manufacture, an apparatus, a system, and as a set of computer-readable descriptions and/or instructions embedded on and/or in a computer-readable medium such as a computer-readable storage medium. In this specification, these implementations, or any other form that the invention may take, may be referred to as techniques. The Detailed Description provides an exposition of one or more embodiments of the invention that enable improvements in features such as performance, power utilization, cost, scalability, efficiency, and utility of use in the field identified above. The Detailed Description includes an Introduction to facilitate the more rapid understanding of the remainder of the Detailed Description. The invention encompasses all possible modifications and variations within the scope of the issued claims.

### Introduction

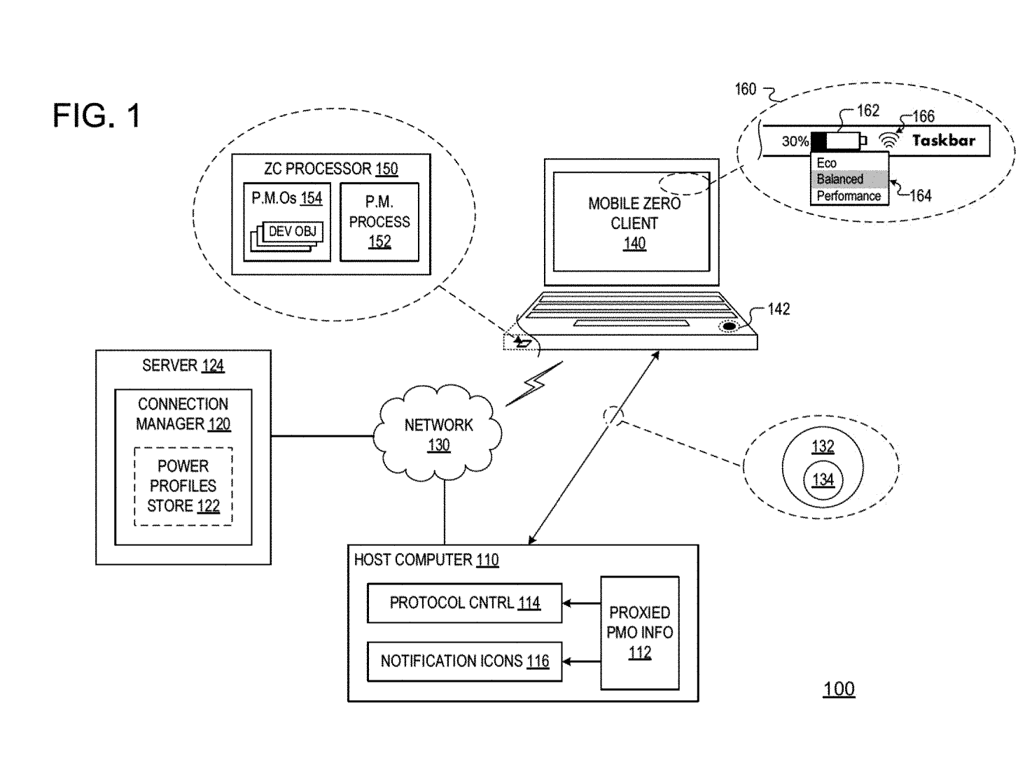

In one or more embodiments of the present invention, a computing system, such as remote computing system 100 (or, system 100) in FIG. 1, comprises a connection manager configured to facilitate the establishment of a remote computing session between a virtual desktop or hosted application on a host computer and a mobile zero client (or, zero client) comprising at least a zero client processor. The mobile zero client operates according to a power management profile in compliance with power settings either configured at the host computer and stored under management of the connection manager at the mobile zero client or configured locally at the mobile zero client. The power status of specified client sub-systems is conveyed to the host computer within the security context of the remote computing session. The conveyed status is used by host software to provide an indication of the mobile zero client state using icons and/or display alerts conventional to the host operating system. Furthermore, the power status information received by the host computer is used to dynamically adapt the remote computing protocol such that decoding and display resources of the mobile zero client consume less power when desired. In some embodiments, features of the mobile zero client such as near-filed communications (NFC) capabilities, presence detection sensors or lid closure sensors operate in conjunction with power savings processes of the remote computing protocol to provide additional power modes.

FIG. 1 illustrates selected details of an embodiment of a remote computing system 100 (“system 100”) comprising a mobile zero client 140 (zero client 140, or simply client 140) communicatively coupled with a host computer 110 via a computer network 130.

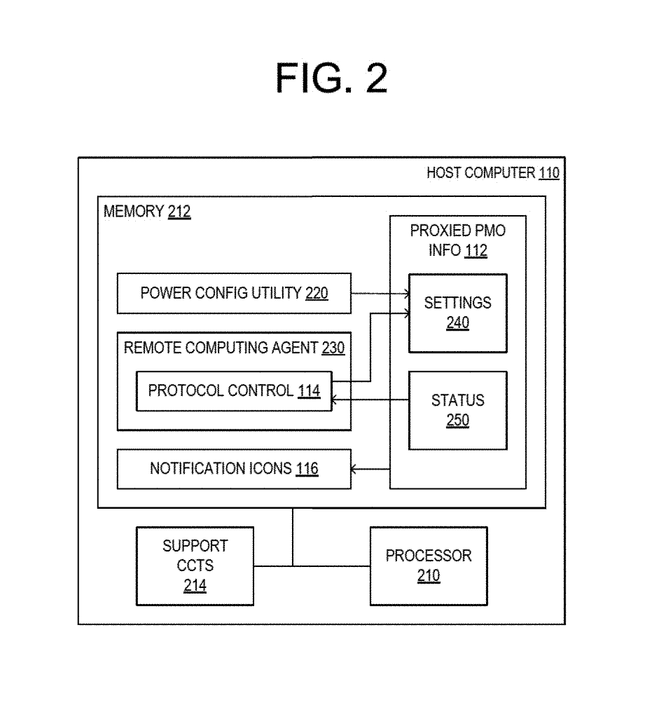

The host computer 110, an embodiment of which is depicted in FIG. 2, comprises a workstation, virtualized desktop, a Remote Desktop Session Host (RDSH) server or application server accessible via a remote computing protocol 132. The remote computing protocol 132 comprises a virtual communications channel 134 designated for the exchange of power status and setting between the host computer 110 and the mobile zero client 140 within the same security context as typical image, audio, control and peripheral data exchanges associated with the remote computing protocol (i.e., the security context defined by common symmetric keys such as a set of AES-256 keys exchanged during negotiation of the remote computing session). Examples of remote computing protocols with virtual communication channel capabilities include Independent Computing Architecture (ICA), PCOIP and Remote Desktop Protocol (RDP) from CITRIX, TERADICI and MICROSOFT corporations respectively.

The network 130 comprises a communication system (e.g., the Internet, local area network (LAN), wireless LAN, wide area network (WAN), and the like) that connects computer systems completely by wire, cable, fiber optic, and/or wireless links facilitated by various types of well-known network elements, such as hubs, switches, routers, and the like. In one embodiment, the network 130 is a shared packet switched network that employs various well-known protocols (e.g., TCP/IP, UDP/IP and the like) to communicate information amongst the network resources. For example, in various embodiments, the network 130 employs part of the Internet.

Server 124 comprises the connection manager 120 enabled to manage lists or pools of users, desktops and application resources and facilitate the establishment of secure and authorized connections between authenticated clients and hosted applications or desktops. In an embodiment, the connection manager 120 is further enabled to store power profile information (e.g., user settings for specifying low power thresholds and/or settings for specifying behavior of mobile zero client 140 and/or behavior of remote computing protocol 132 related to reduced power operation) in power profiles store 122. For example, in an embodiment, the connection manager communicates select thresholds to host computer 110 such as the battery capacity threshold for a mobile zero client 140 below which the host computer operates the remote computing protocol at a defined minimum image update period. In some embodiment, the power profile store 122 may be separated from connection manager 120 (such as incorporating power profile store 122 into MICROSOFT Active Directory or stored on a separate server). In other embodiments, power profiles may be stored locally at mobile zero client 140 or locally at host computer 110. According to one embodiment, one or more connection managers, including those from service providers or well-known enterprise brokers such as VMware Horizon connection server, Citrix Desktop Studio, Amazon Workspaces or Ericom Blaze are enhanced to provide storage facilities for power profiles, thereby enabling a user to access host computer 110 from different mobile zero clients using consistent profiles.

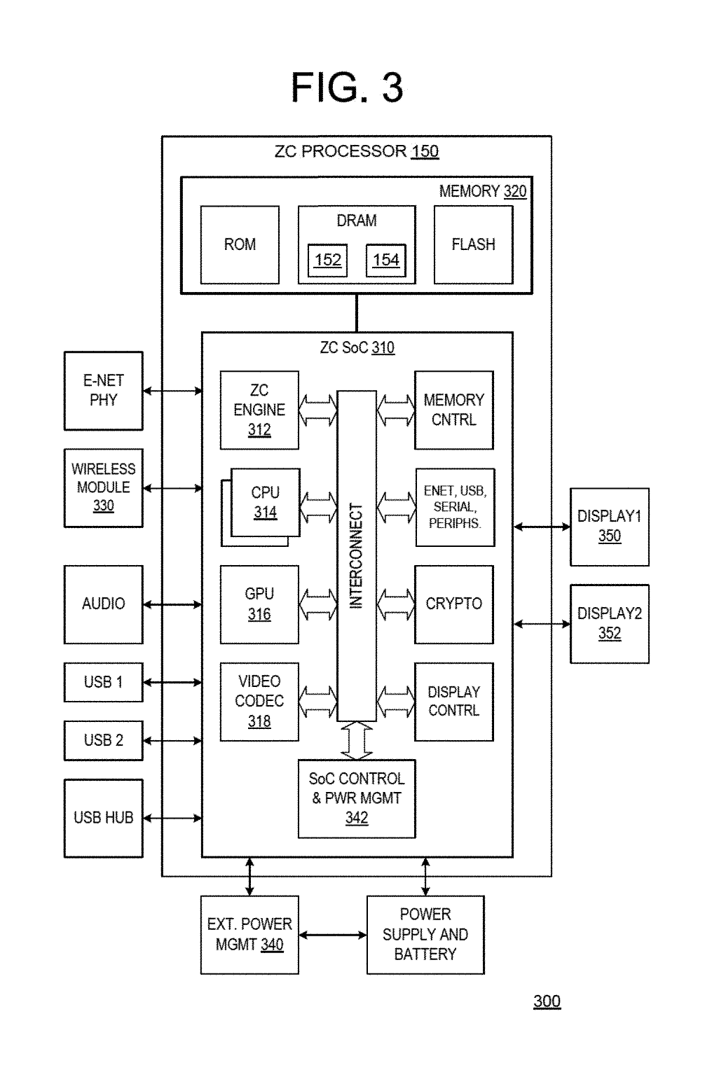

According to one embodiment, the mobile zero client 140 comprises a laptop or tablet-styled device with a zero client (ZC) processor 150 coupled to network 130 by a wireless connection such as a 3G or 4G cellular connection or an IEEE 802.11 Wi-Fi connection. An embodiment of ZC processor 150 is described in association with FIG. 3. In some embodiments, mobile zero client 140 comprises an RJ-45 Ethernet jack for connection to an IEEE 802.3 powered Ethernet (PoE) connection. Generally, the mobile zero client 140 comprises input facilities (e.g., keypad, touchscreen, gesture sensors and the like) and a display for remote interaction with host computer 110. In some embodiments, the client 140 comprises one or more sensors 142 such as a lid sensor (i.e., lid open′ or lid closed′), light sensor, presence sensor or Near Field Communications (NFC) antenna represented by Power Management Objects (PMOs) 154 and utilized to improve the power efficiency of mobile zero client 140 described by methods in the present specification.

In some embodiments, mobile zero client 140 comprises a kiosk or digital signage system such as, or LCD, OLED, persistent display or projector optionally with audio devices (i.e., microphone and/or speakers) and ports such as USB interfaces for mouse and keyboard. Some such digital signage embodiments comprise built-in or external webcam, light sensor and presence detection mechanism represented by PMOs 154 and utilized to improve the power efficiency of mobile zero client 140 also described by methods in the present specification.

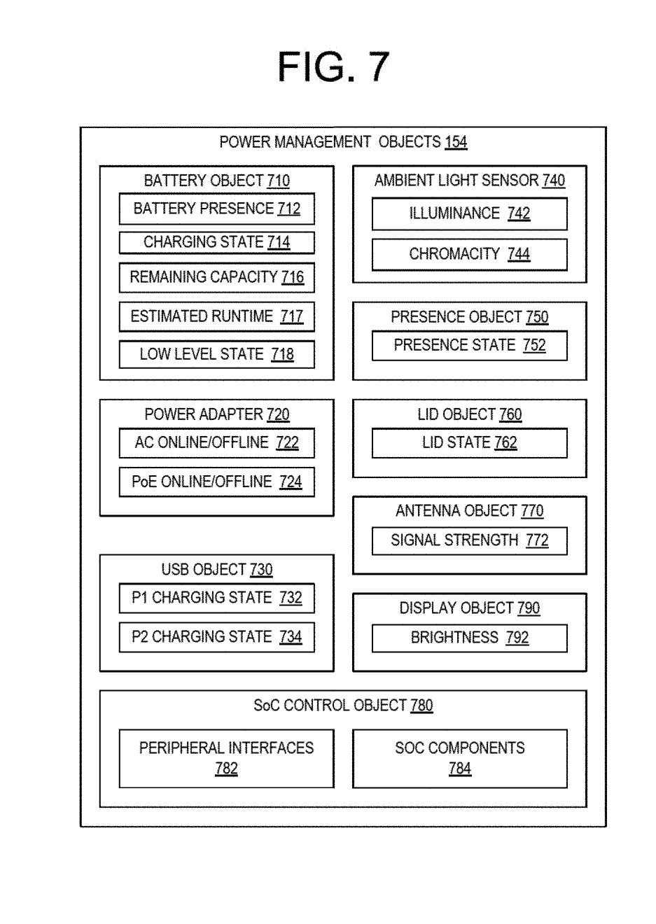

According to one embodiment, the ZC processor 150 executes power management process 152 wherein the actions taken by the power management process are at least in part specified by PMOs 154, an embodiment of which is depicted in FIG. 7. The PMOs are proxied over the virtual communication channel 134 to host computer 110 where state information is maintained as proxied power management object information 112 (PMO information 112) and used as input information to protocol control process 114, notification icon 116 and optionally alternative user alerts such as pop-up alerts, dialog boxes, sound alerts or status display structures integrated with the operating system or proprietary application software. In an embodiment, the notification icons are presented in the taskbar of the operating system of host computer 110. Once the desktop image of host computer 110 has been transmitted to mobile zero client 140, the taskbar portion 160 of the desktop image presents host-rendered icons such as battery status icon 162 and wireless signal strength icon 166. In an embodiment, power profile menu 164 is activated by hovering a mouse over battery status icon 162 or using a predefined hotkey and the client power profile is changed by making a selection. PMOs 154 are updated via virtual communications channel 134 which alleviates the need for a user to require browser software or alternative low-level configuration utility in order to directly access and change PMOs 154. According to another embodiment, power management is executed at least in part by the host computer 110. For example, host computer 110 may determine the power state and brightness of display devices based on battery status information provided via proxied PMO information 112. In some such embodiments, administrative policies set based on client device type (e.g., mobile client type, projector client type, kiosk client type, desktop client type and the like) and/or user profiles govern the subset of power state management functions executed by ZC processor 150 and subset of power state management functions executed by host compute 110. Such an approach enables a policy-based approach to managing the power modes and sleep states of client devices and their peripherals.

In some embodiments, a mobile zero client 140 or a host compute 110 may comprise a power profile specified by a user whereas connection manager 120 stores a series of power profiles as determined by corporate policies. The power profile used for a particular session is governed by administrative policies.

FIG. 2 is an illustration of an embodiment of host computer 110 such as a workstation or server comprising well known hardware components including processor 210, memory 212 and support circuits 214 which includes a network interface to network 130. Memory 212 generally comprises well-known operating system, driver software, application software and the like not depicted in FIG. 2. Memory 212 further comprises remote computing agent (RCA) 230 which provides host termination functions for remote computing protocol 132, including security functions, display image encoding functions, audio codec, remote peripheral device interface functions, and protocol functions such as packet handling, error recovery and bandwidth management. Display image encoding functions generally comprise a lossless encoder for text regions of the display, a lossy encoder such as JPEG or wavelet based encoder for graded image areas (i.e., ‘natural images) and optionally one or more video encoders such as H.264 Advanced Video Coding (AVC) or H.265 High Efficiency Video Coding (HEVC) for moving images. In some embodiments, one or more functions of RCA 230 may be executed by a Graphics Processing Unit (GPU) or hardware-based encoder installed in host computer 110.

In an embodiment, memory 212 comprises a power configuration utility 220 for configuring power management settings 240 for mobile zero client 140, including settings associated with the behavior of RCA 230 such as default operational performance preference (e.g., ‘power saver’, ‘balanced’ or ‘high performance’) set via power profile menu 164, configurable battery thresholds and associated operational performance, and sensor-driven behavior preferences. Power configuration utility 220 may comprise proprietary software related to mobile zero client 140 and/or may comprise native tools inherent to the operating system of host computer 110 enabled to differentiate between power management settings associated with host computer 110 itself and those power management settings associated with mobile zero client 140. In an alternative embodiment, power configuration utility 220 is an administration tool with an interface to connection manager 120 that enables IT administrators to apply power management settings across pools of users or across similar client device types.

Status information 250 comprises proxied status information such as battery level, power source or mobile zero client sensor status designated as input parameters for protocol control process 114.

FIG. 3 is an illustration of an embodiment of a ZC processor 150 comprising a ZC system on chip (SoC) 310 coupled to well-known memory components 320. Generally, SoC 310 comprises one or more well-known functional blocks such as Central Processing Unit 314, GPU 316 and video codec 318, in addition to memory controller, peripheral device interfaces, Universal Serial Bus (USB) interfaces, display interfaces to a display 350 and a secondary display 352, audio interfaces, encryption functions, display controller and system control function known in the art. Furthermore, SoC 310 comprises ZC engine 312 enabled with hardware-based image decoder functions (e.g., JPEG, wavelet, H.264, H.265, entropy and/or dictionary decoders) in addition to audio codec, packet processing, error recovery, caching and bandwidth management functions complementary to the functionality of RCA 230.

In addition to functions such as ZC engine configuration and remote computing session negotiation, CPU 314 executes power management process 152, generally under control of a BIOS and real-time operating system such as THREAD-X from Express Logic Inc. or QNX from BlackBerry. In an embodiment, power management process 152 comprises functions such Advanced Configuration Power Interface (ACPI) software driver and ACPI Machine Language (AML) interpreter compliant with the ACPI specification. In such an embodiment, PMOs 154 comprise device-specific objects compliant with definitions for an ACPI namespace as defined by the ACPI Specification (a joint publication from HP, INTEL, MICROSOFT, PHOENIX, and TOSHIBA corporations). In another embodiment, PMOs 154 comprise at least one list of settings and status information used by power management process 152. In such an embodiment, power management process 152 advances one or more power management state machines and affects the operational state of functional blocks of ZC processor 150 and its peripheral device interfaces. In either such embodiments, CPU 314 aggregates settings and/or state information relevant to protocol control process 114 or notification icons 116 and transmits said information to host computer 110 where it is maintained as proxied PMO information 112 typically for the duration of a remote computing session.

The external power management module 340 provides power management of ZC processor 150 and circuitry of mobile zero client 140 such as display panel(s), USB hub(s) and audio circuits. Power management of components of the SOC itself including GPU 316, video codec 318 and peripheral interface circuits including display controller and display interfaces, Ethernet interface, audio interface, memory interface, USB interfaces and the like are under control of SoC power management and control module 342. In an embodiment, the functionality of the external power management module 340 and the SoC power management and control module 342 is governed by the state of one or more PMOs 154, thereby enabling software executed by host computer 110 and/or power management process 152 to monitor and control the various circuits of mobile zero client 140. For example, in an embodiment sleep states for the GPU 316, the video codec 318 and one or more display interfaces is activated when host computer software changes settings of related proxied PMO information 112. In another embodiment, SoC power management and control module 342 activates sleep modes of external displays based on PMO information, using for example power management controls available via the VESA standardized Display Data Channel (DDC) interface between ZC processor 150 and a secondary display 352, wherein in one embodiment the secondary display 352 is an external display.

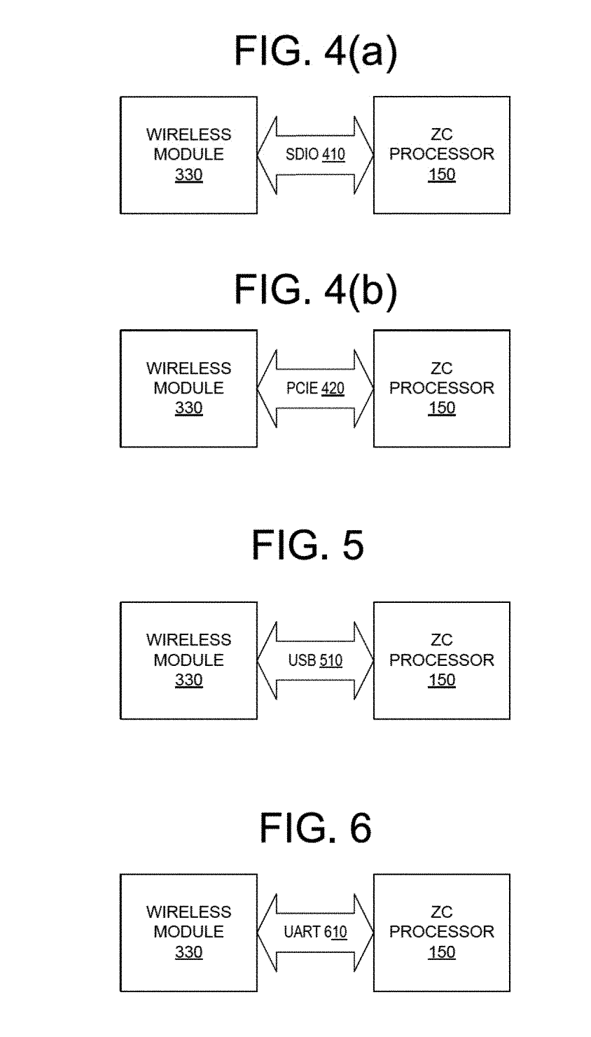

In an embodiment, wireless module 330 is an expansion module compliant with M.2 (i.e., Next Generation Form Factor, or NGFF), USB or PCI Express Mini Card standards enabled with a well-known multi-band (e.g., 2.4 & 5 Ghz) multi-standard (e.g. IEEE 802.11 & Bluetooth & NFC standards) radio SoC from vendors such as QUALCOMM ATHEROS, MARVELL, MEDIATEK or BROADCOM Corporations. ZC processor 150 is coupled to wireless module 330 using any of several techniques including those specified by the NGFF standard. For example, a Secure Digital Input Output (SDIO) 410 interconnect is depicted in FIG. 4(a) and a Peripheral Component Interconnect (PCI) Express interconnect 420 is depicted in FIG. 4(b), a USB bus 510 interconnect is depicted in FIG. 5 and a Universal Asynchronous Receiver/Transmitter (UART) coupling 610 is depicted in FIG. 6. Interconnects 410, 420 and 510 are generally suitable for any combination of WiFi, Bluetooth and NFC communications whereas the limited bandwidth provided by interconnect 610 generally restricts the functionality of module 330 to Bluetooth and/or NFC communications in such a configuration.

By coupling wireless module 330 to ZC processor 150 via an SDIO, PCI Express or USB connection, configuration menus (e.g., On Screen Display menus) executed by CPU 314 used to configure ZC Engine 312 and peripheral interfaces of SoC 310 incorporate functions for configuring the wireless module 330. This approach eliminates the complexity associated with previous generation wireless processors which required separate configuration facilities, including additional CPU resources and complex multiplexors for sharing keyboard, mouse and display signals with previous generation ZC processors.

FIG. 7 depicts a set of PMOs 154, each PMO comprising data useful as proxied information at host computer 110. In different embodiments, the PMOs 154 are implemented as a simple dynamic status list or alternatively in the context of an ACPI-compliant namespace.

Battery power management object 710 comprises at least one of battery presence indicator 712, charging state 714, remaining capacity value 716, estimated runtime value 717 and low level state 718. In an embodiment, low level state 718 is set by Power management process 152 to one of four states typically designated by the battery manufacturer (i.e., ‘healthy’, ‘warning’, ‘low’ and ‘critical’ states). Power adapter objects 720 comprise at least one of AC state 722 and PoE state 724 (i.e., online or offline) states. USB objects 730 comprise representations of USB ports enabled with device charging capabilities. For example, a mobile zero client with two such ports comprises P1 and P2 charging states 732 and 734 respectively. Once proxied to host computer 110, indicators such as battery presence 712, charging state 714, remaining capacity value 716, estimated runtime 717, low level state 718, power adapter objects 720 and USB objects 730 are depicted graphically (e.g., via notification icons 116) in some embodiments. Additionally, in some embodiments remaining capacity value 716, low level state 718 and power adapter objects 720 are used by protocol control process 114 in conjunction with user-defined set points to adjust the performance of RCA 230 in accordance with power availability.

In embodiments in which mobile zero client 140 comprises an ambient light sensor, ambient light sensor object 740 comprises illuminance indicator 742, complemented by chromacity indicator 744. Ambient light information is used by protocol control process 114 to adjust image quality, for example in direct sunlight, which reduces display protocol bandwidth requirements and associated power consumption at mobile zero client 140.

Presence object 750 associated with a presence sensor that determines whether a user is present at the mobile zero client 140 or not, comprises presence state 752 (i.e., ‘present’, ‘absent’ or ‘unknown’ states). Presence information may be used by protocol control process 114 to adjust attributes of the display image and/or audio signal, useful for power conservation in general and digital signage applications in particular. Presence information may also be used in conjunction with the lid state 762 (associated with lid object 760) to extend the period between lid closure of mobile zero client 140 and the time at which the ZC processor 150 disconnects from host computer 110 or other low power operational modes such as an ‘audio-only’ mode (which may use lid state 762 with or without presence state 752 in different embodiments). A ‘suspend’ mode (i.e., delayed disconnect triggered by a lid sensor) provides power savings and efficiency in an enterprise environment by enabling a user to suspend a remote computing session at a first location (e.g., a desk) and resume the same remote computing at a second location (e.g., a meeting room) without authentication. The duration of such a suspend mode is determined by a policy setting, remaining battery capacity and location information of the mobile zero client 140 tracked by the connection manager 120 or security appliance in different embodiments.

Antenna object 770, associated with wireless module 330, comprises signal strength indicator 772 which, in an embodiment is presented as an icon at host computer 110 in a familiar representation.

SoC Control object 780 associated with external power management module 340 and SoC Power Management and Control module 342 comprises state information and control fields for peripheral interfaces (ref. peripheral interfaces 782) and state information and control fields for SoC components (ref. SoC components 784). In an embodiment, sleep states for display, USB, Ethernet and audio peripherals are set by manipulating the state of peripheral devices 782 and sleep states for components internal to ZC processor 150 including GPU 316, video codec 318 and interfaces such as USB, serial, Ethernet, display interfaces and the like are set by manipulating the state of SoC components 784.

Display object 790 interfaces for displays 350 and 352 comprises brightness parameter 792 which, in an embodiment present proxied PMO brightness setting 240 at host computer 110 available for brightness control by power configuration utility 220 or protocol control process 114.

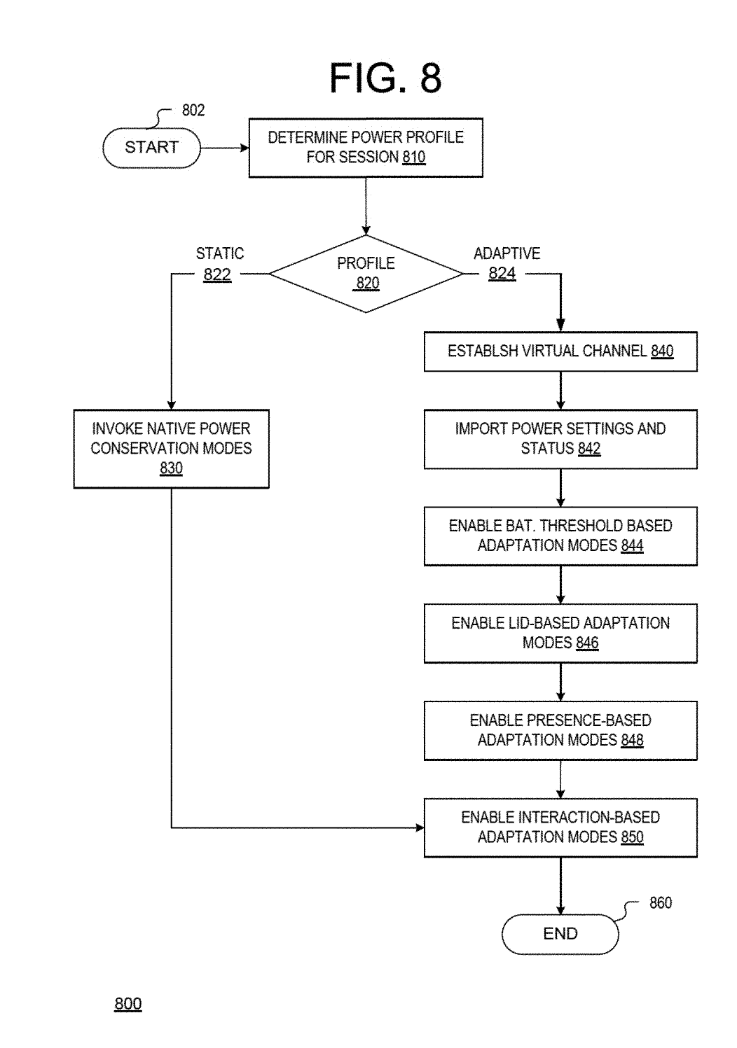

FIG. 8 illustrates a flow diagram for a method 800 for configuring a host computer 110 based on a particular power profile required for a session. Method 800 starts at step 802 and proceeds to step 810 (‘Determine Power Profile for Session’) in which the power profile for a particular combination of user identity and client device identity is determined. In one embodiment, a client device contacts a connection manager 120 during session negotiation and the connection manager accesses a desired power profile from power profile store 122 based on at least one of the client identity and the user identity, for example as determined by administrative policies and/or previously saved user preferences. The selected power profile is then passed to host computer 110 during session instantiation (either via the client or from the connection manager 120 to host computer 110). In another embodiment in which a power profile is configured and stored at the client, for example via a browser interface independent of a remote computing session, the power profile is communicated to the host computer during session instantiation.

At step 820, host computer 110 retrieves the protocol control and notification requirements of the power profile. In case 822 with static requirements, for example when a client is inherently wall powered or a mobile zero client is not enabled to proxy power state information, method 800 proceeds to step 830 (‘Invoke Native Power Conservation Modes’) in which host computer 110 operates strictly in the context of ACPI definitions for the host environment, protocol control process 114 is disabled or configured with static values suitable for a wall powered client and no virtual channel is established for exchanging power information with the client. Method 800 then proceeds to step 850, where interaction-based adaptation modes are enabled, wherein, for example, RCA 230 increases the image update period in proportion to the level of user interactivity. For example, when a high level of user interaction is detected by a continuous stream of mouse events associated with a mouse drag operation (e.g., window drag), a short image update period such as 33 ms is specified but when no user interaction is present, the image update period is increased to 125 ms. Furthermore, the image update period may be weighted by the remaining battery capacity such that the image update period is reduced when the battery is charged but extends as the remaining battery capacity is reduced. The method terminates at step 860.

In case 824 with dynamic requirements, for example when a client such as mobile zero client 140 is enabled to proxy dynamic power information, method 800 proceeds to step 840 (“Establish Virtual Channel”) in which virtual communications channel 134 is established for the remote computing session between host computer 110 and mobile zero client 140.

Method 800 proceeds to step 842 (“Import Power Settings and Status”) in which settings 240 and status 250 (i.e. one or more of the various data objects 710 thru 770) are loaded and synchronized from the power profile.

If threshold-based adaptation is enabled, method 800 proceeds to step 844 (“Enable Battery Threshold-based Adaptation Modes”) wherein, for example, RCA 230 increases the image update period, thereby reducing the image frame rate as a power conservation measure. In an embodiment, power settings software on host computer 110 provides a user-specified setting as a target ‘time remaining’, following which RCA 230 dynamically adjusts user experience related protocol parameters (e.g., image update period, video content frame rate, reduced audio, codec selection parameter used to invoke selection of a particular codec or brightness of the display backlight of the client 140, or pixel decimation factor) and monitors related PMOs (e.g., remaining capacity value 716 and/or estimated runtime 717) to meet the specified target. A pixel decimation factor dictates spatial decimation by sub-sampling the source image or averaging adjacent pixels. For example, a pixel decimation factor increase from one to two in both X and Y reduces the spatial resolution of the image processed by a remote computing image encoder by a factor of four. In another embodiment, power settings software on host computer 110 provides a slider widget spanning a range of target “time remaining” that operates in conjunction with a set of display notifications that display estimates of user experience parameters. Such an approach optimizes user experience in consideration of power constraints. As a particular example which should be understood not to limit the present invention, a slider may provide a range from ‘3 Hours’ to ‘6 Hours’ remaining for a substantially charged battery. At the ‘3 Hours’ slider mark, corresponding display notifications may indicate a maximum frame rate of 30 frames per second (i.e., a minimum image update period of 32 ms), a maximum image quality as lossless' and a display brightness of 100%. At the ‘6 Hour’ slider mark, the display notifications may change to indicate a maximum frame rate of 8 frames per second, 70% maximum image quality and a display brightness of 50%. In other embodiments, such power management software supports adjustment of the individual weighting that each user experience attribute contributes to the overall time remaining. If lid-based adaptation is enabled, method 800 proceeds to step 846 (“Enable Lid-based Adaptation Methods”) wherein, for example, RCA 230 suspends image updates but maintains a security context. If presence-based adaptation is enabled Method 800 proceeds to step 848 (“Enable Presence-based Adaptation Methods”) wherein, in the case of a digital signage example, RCA 230 refreshes the display image when a user is confirmed as present. An embodiment of a power adaptation method encompassing battery-, lid- and presence-based adaptation modes is described by method 1100.

If interaction-based adaptation is enabled, method 800 proceeds to step 850 (“Enable Interaction-based Adaptation Modes”) wherein, for example, RCA 230 increases the image update period in proportion to the level of user interactivity. For example, when a high level of user interaction is detected by a continuous stream of mouse events associated with a mouse drag operation (e.g., window drag), a short image update period such as 33 ms is specified but when no user interaction is present, the image update period is increased to 125 ms. Furthermore, the image update period may be weighted by the remaining battery capacity such that the image update period is reduced when the battery is charged but extends as the remaining battery capacity is reduced.

Method 800 exits at step 860 (“End”).

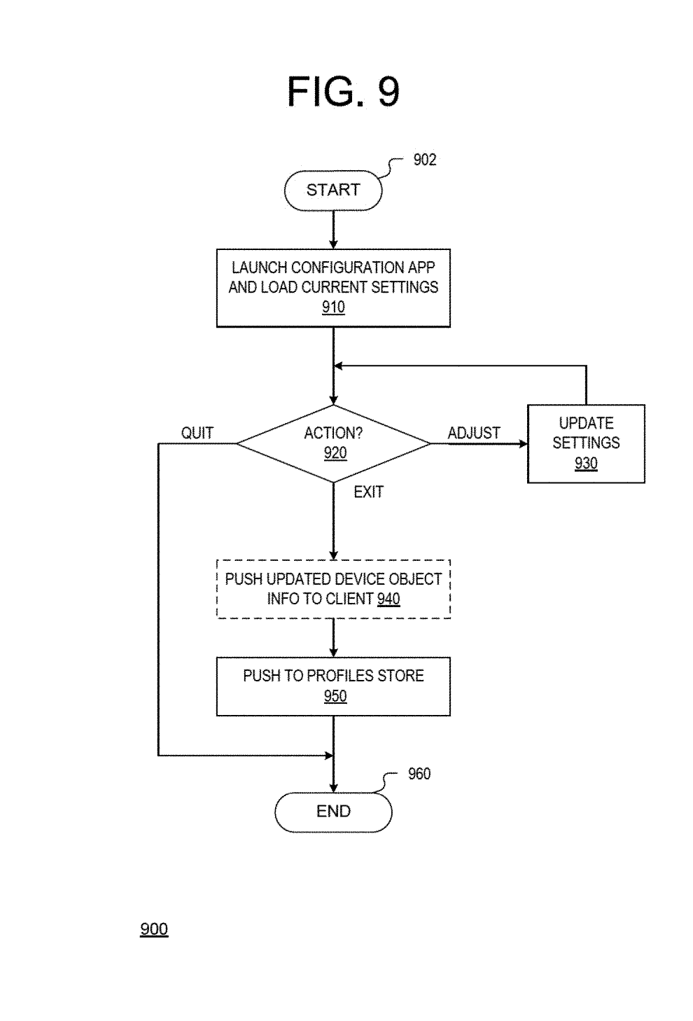

FIG. 9 illustrates a flow diagram for a method 900 for managing power-related settings of a client such as mobile zero client 140 from a host computer 110 or an administrative console associated with connection manager 120. Method 900 starts at step 902 and proceeds to step 910 (“Launch Configuration Application and Load Current Settings”) in which a proprietary software application or operating-system utility is launched and current settings 240 are accessed from proxied power management object information 112 or power profiles store 122. In some embodiments, settings 240 are strictly applicable to controlling the functionality of host computer 110 (e.g., via protocol control process 114). In other embodiments, one or more settings are applicable to the functionality of mobile zero client 140 (e.g., threshold triggered display brightness or threshold triggered USB charger services).

If, at step 920, the user engages in an action such as entering changed settings, method 900 proceeds to step 930 (“Update Settings”) in which the configuration application reflects the changed settings, for example as updated values or highlighted configurations. The method then returns to step 920 to wait and determine if a user has engaged in an action. If, at step 920, the user exits (i.e., ‘save and exit’), method 900 proceeds to step 940 (“Push Updated Device Object Information to Client”) in which adjusted settings 240, if applicable to power management process 152 or are maintained by the client as a policy, are communicated to mobile zero client 140 and synchronized with PMOs 154. Method 900 proceeds to step 950 in which updated settings are communicated to power profile store 122. If, at step 920, the user quits the application (i.e., ‘cancel’), method 900 purges any updates from step 930 and proceeds to step 960 where method 900 terminates.

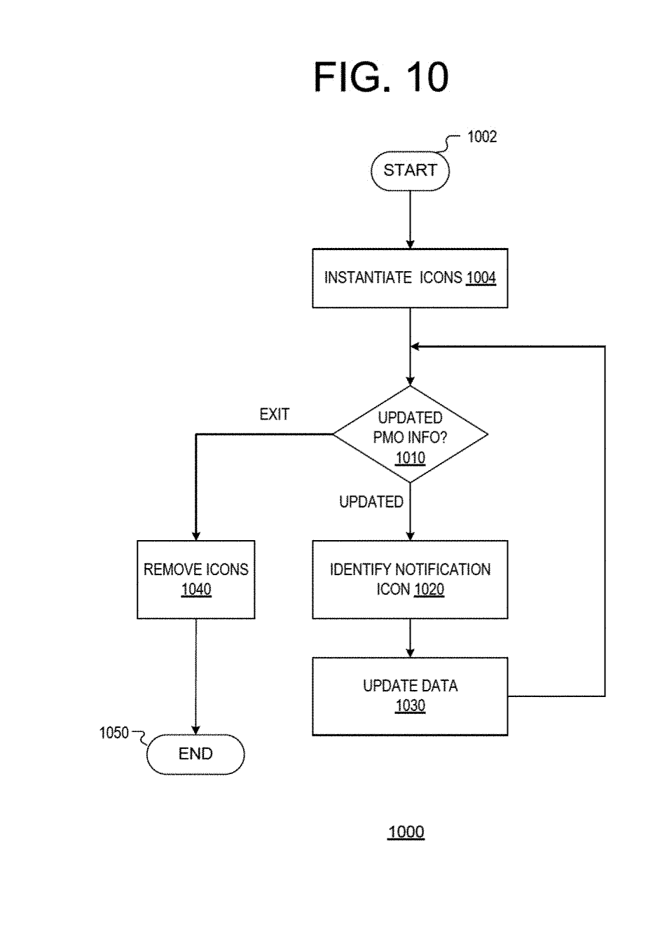

FIG. 10 illustrates a flow diagram for a method 1000 in which notification icons of host computer 110 convey dynamic information related to mobile zero client 140 including at least one of power-, peripheral- and antenna-state information.

Method 1000 starts at step 1002 and proceeds to step 1004 (“Instantiate Icons”), for example at the start of a remote computing session, in which notifications icons are added to the taskbar using well-known software programming techniques. Method 1000 proceeds to step 1010 (“Updated PMO Info?”) to determine wither PMO information has been updated. In an embodiment, a callback function is registered with the operating system which facilitates the execution of steps 1020 and 1030 when there is a change in status 250 relating to an instantiated notification icon. In another embodiment, step 1010 comprises a polling function which periodically evaluates status 250 for changes. In the event of an updated status at step 1010, method 1000 proceeds to step 1020 (“Identify Notification Icon”) in which the icon pertinent to the changed proxied PMO is identified. For example, in a typical WINDOWS embodiment, notification icons are identified according to a globally unique identifier (GUID). Method 1000 subsequently proceeds to step 1030 in which the data (e.g., battery remaining capacity, power adapter state, wireless signal strength and the like) associated with the icon is updated and then returns to step 1010. In the event of a requirement to exit method 1000, such as the termination of a remote computing session, method 1000 proceeds to step 1040 in which icons instantiated at step 1004 are removed and method 1000 terminates at step 1050.

The use notification icons exemplified in method 1000 represents just one technique for user notification which may be augmented or supplemented by alternative notification techniques. For example, low battery alerts are generally better displayed as Windows dialog boxes in conjunction with a warning icon and “OK” button which demands the user's attention.

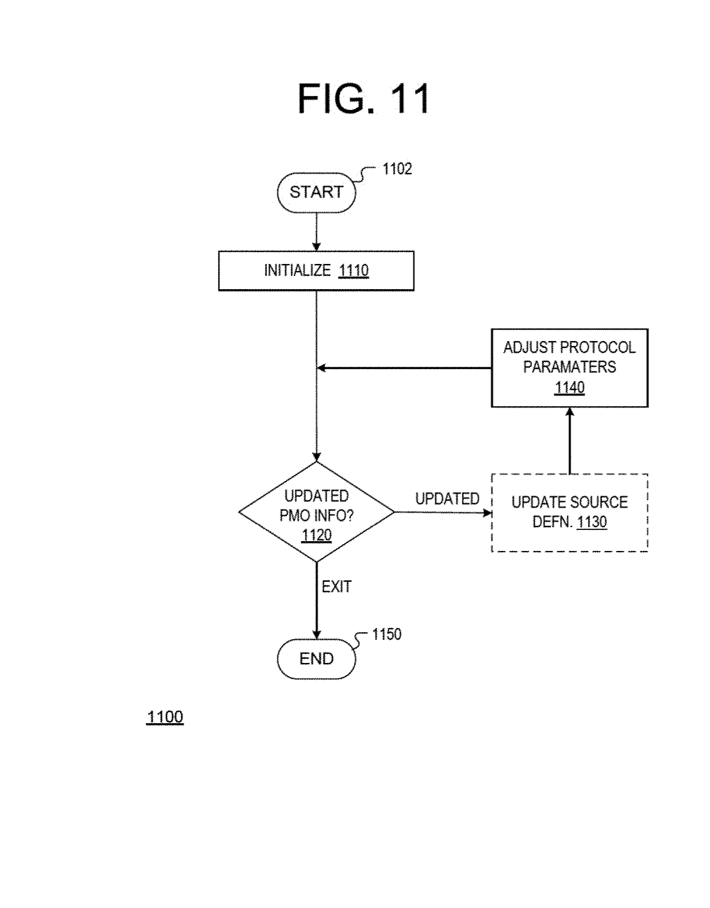

FIG. 11 illustrates a flow diagram for a method 1100 in which RCA 230 is configured to respond to the state of mobile zero client 140 as reflected by proxied PMO information 112.

Method 1100 starts at 1102 and proceeds to step 1110 (“Initialize”) in which a source definition is selected and initial conditions for settings 240 and status 250 are used by protocol control process 114 to specify the initial behavior of RCA 230. The source definition identifies the display image source buffer, specifies display attributes such as display resolution and optionally additional media sources such as audio associated with a remote computing session. By default, the standard display image source (e.g., the active WINDOWS display adapter in the case of a frame buffer as image source or a physical display source such as DisplayPort) is defined for the image component of the source definition. By default, the active audio driver is defined for the audio component.

In an exemplary embodiment, the maximum frame rate for encoded images is set to 60 frames per second if an AC power source is detected. If a battery source is detected, 30 frames per second is selected for maximum frame rate if the remaining battery capacity exceeds all defined battery level thresholds but the image update period is increased proportionally as the remaining capacity value decreases. If the remaining capacity falls below a specified threshold, the image update period may be specified as a minimum limit to prevent excessive frame rates. In another embodiment, the maximum frame rate for encoded images is set to 16 frames per second and the Build-to-Lossless (BTL) feature popular amongst remote computing protocols is disabled if a ‘power saver’ power profile is selected.

Method 1100 proceeds to step 1120 (“Updated PMO Info?”) where proxied PMO information 112 is evaluated for any changes such as a change in presence, lid state, low level battery state alert or battery capacity falling below a specified threshold. In event of a change, method 1100 proceeds to step 1130 (“Update Source Definition”). Step 1130 is bypassed if no source definition update is required.

At step 1130, the source definition is updated if the updated PMO requires different image or audio experience characteristics as defined by the power profile. In an embodiment, the image source is suspended or changes to a blank display or a defined image file when the presence object 750 changes from ‘present’ to ‘absent’ or when the mobile zero client 140 has determined no user activity for a predefined period of time. In another embodiment, the audio source is muted too. In another embodiment, the updated source comprises an image sequence and timing information enabling offline replay of the image sequence after it has been downloaded to mobile zero client 140 and the remote computing session has been terminated or suspended. In another embodiment, the image sequence is accompanied by an audio file which can be played offline. In another embodiment, a lower display resolution is negotiated in the presence of limited remaining battery capacity. In another embodiment, desktop wallpaper is replaced with a blank image (e.g. a black picture) and/or the fonts used by the operating system are reconfigured from anti-aliased text or ClearType text to block text type which typically achieve higher compression ratios and require less bandwidth. In another embodiment, the image and/or audio source is identified as content pre-cached in memory 320 of the ZC processor. In yet another embodiment in which a lid sensor indicates a ‘lid closed state’ in the presence of active audio application software such as ITUNES, the image source changes to a blank display and/or the display brightness is dampened but the audio stream remains active in the presence of an AC power source or sufficient remaining battery capacity. Generally, if a lid is re-opened or presence status indicates the arrival of a user, the source definition is updated to default display image and audio source components.

In an embodiment, adjustment of the source definition comprises adjusting image translation applied to the source image. For example, the chroma content for portions of the source image may be translated (e.g. conversion from well-known YUV 4:4:4 to well-known 4:2:0 format or conversion from ClearType text format to grey scale text format). As another example the spatial resolution of select portions of the source image are reduced. As another example, update rates for select portions of the source image are reduced. In another embodiment, adjustment of the source definition comprises adjusting operating system visual effects (e.g. font smoothing animation and or fading effects, showing window contents while dragging, image content generation and the like) applied to the source image.

At step 1140 (“Adjust Protocol Parameters”), protocol control process 114 adjusts parameters of RCA 230 if different protocol performance is demanded (i.e. according to updated PMO values). In an embodiment, the encoded image frame rate is incrementally reduced, for example from 30 fps to 8 fps at various thresholds of remaining battery capacity between 100% and the first battery warning level. In another embodiment, natural image portions of the display image are decimated and/or quantized at a determined battery threshold. In another embodiment, the encoded audio quality is reduced, for example from 128 kbps to 16 kbps, when a battery warning is encountered. In another embodiment, the BTL feature is disabled at a determined battery threshold (e.g. warning level) or user ‘absence’ to reduce power consumption related to radio activity and memory bandwidth at ZC processor 150. To a similar end, the progressive encoding rate (i.e. rate at which the quality of static image portions are improved) may be changed to reduce wireless transmission activity. Similarly, an HEVC video encoder tasked with encoding a region of changing pixels (i.e. a detected video region) is replaced with an AVC encoder and/or the coding profile is changed to reduce power consumption of ZC processor 150 under remaining battery capacity constraints or in the presence of direct sunlight as indicated by ambient light sensor 740 or user absence indicated by presence state 752. In another embodiment, a video encoder engages Complexity Adjustable Motion Estimation (CAME) in order to skip sub-pixel motion estimation which reduces power consumption of ZC processor 150. In another embodiment, the image compression method used by RCA 230 is changed under remaining battery capacity constraints in order to engage more power-efficient decoder resources of ZC processor 150 at the expense of image quality or user interactivity. In an exemplary embodiment, RCA 230 switches from a decomposition based encoder (i.e. an encoder codec that uses lossless text encoding techniques for text and icon image content but uses lossy encoding techniques such as JPEG or wavelet encoding for natural image content such as pictures) when selecting a codec to video-based encoding such as H.264 AVC encoding for the entire desktop display image. At the same time, the decoder utilized by ZC processor 150 is re-negotiated from ZC engine 312 (or a software decoder executed by CPU 314) to a more power efficient H.264 decoder (i.e. video codec 318). In another embodiment in which GPU 316 is tasked with composing a plurality of images received from one or more host computers 110, image composition functions are reverted to host computer 110 and the image composition features of GPU 316 disabled under power constraint. In various embodiments, audio parameters are changed for power efficiency. For example, audio quality is reduced or the audio codec is switched from a low-latency audio codec (at a limited level of audio compression) to a high latency audio codec (with an increased level of audio compression).

On termination of a remote computing session, method 1100 terminates at step 1150.

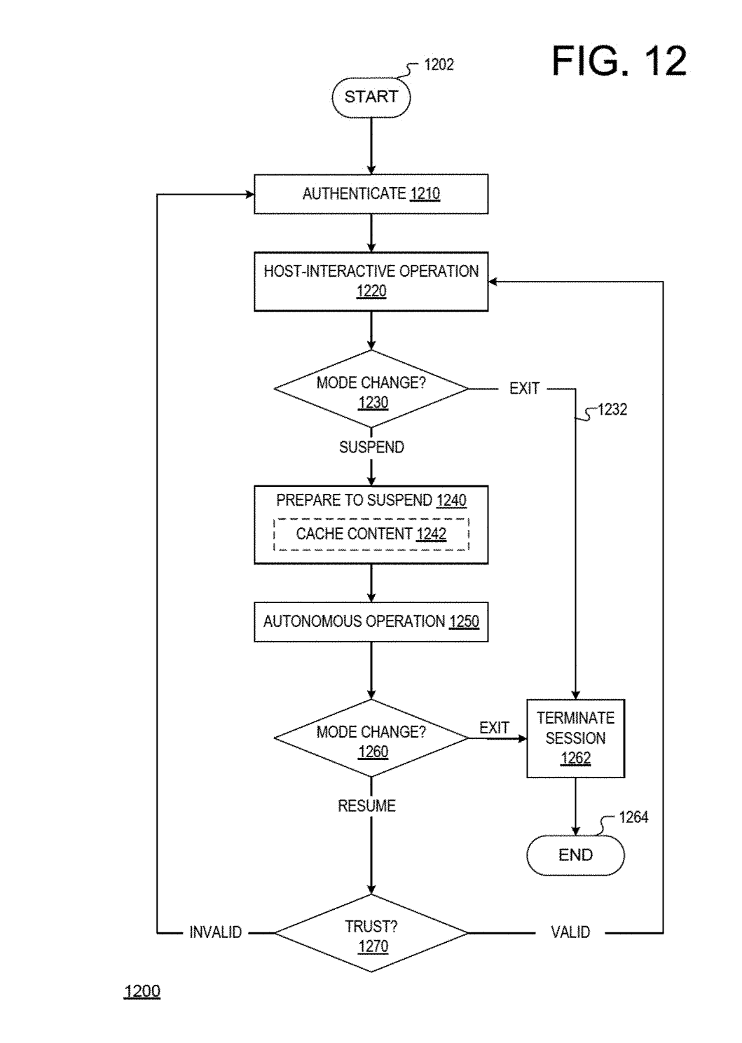

FIG. 12 illustrates a flow diagram for a method 1200 in which a mobile zero client 140 transitions between host-interactive operation and autonomous operation for purposes of power and/or network utilization efficiency. Method 1200 starts at 1202 when there is remote computing session active, for example following power-up.

Method 1200 proceeds to step 1210 (“Authenticate”) during which user credentials are submitted from mobile zero client 140 to connection manager 120. In ‘direct connect’ embodiments in which client 140 contacts host computer 110 without the services of connection manager 120, the user credentials may be submitted directly to host computer 110. After the user has been authenticated, symmetric keys such as Advanced Encryption Standard (AES) compliant keys are exchanged between host computer 110 and mobile zero client 140 over a secure channel, typically initiated from mobile zero client 140 using a cryptographic protocol such as Transport Layer Security (TLS).

Method 1200 proceeds to step 1220 (“Host-Interactive operation”) in which the symmetric keys exchanged at step 1210 provide the security context for a remote computing session between mobile zero client 140 and host computer 110, the performance of which is determined by protocol settings and policies present at host computer 110. In some embodiments, for example, a digital signage application in which advertisement content comprises streamed segments with logical start and end times, such start and end times may be watermarked by the content provider. In an embodiment, such visual or audio cues extracted by image or audio decoding functions of mobile zero client 140 and are monitored to determine start and end positions for cached content. In another embodiment, such visual or audio cues are extracted from the display image or audio stream by RCA 230 and corresponding timing information is communicated to mobile zero client 140 over virtual communication channel 134. In an embodiment, mobile zero client 140 decodes compressed display image and audio data communicated via remote computing protocol but also engages video encoding features of ZC processor 150 (i.e. video codec 318) to re-encode the decoded content and generate an efficiently compressed format such one or more MPEG-4 encoded multimedia files which are buffered in memory 320 for subsequent offline access.

At step 1230, the client 140 is prompted to change operational mode. In case 1232, for example following the session disconnect or power button being pressed, method 1200 proceeds to step 1262 (“Terminate Session”), in which the remote computing session is gracefully terminated and method 1200 ends at step 1264. If, at step 1230, the mobile zero client 140 receives a trigger to engage in autonomous operation, method 1200 proceeds to step 1240 (Prepare to Suspend”). Mobile zero client 140 engages any one or more of several autonomous modes dependent on the specific trigger. In an embodiment, user absence as detected by a presence sensor, client-terminated webcam, Bluetooth signal strength, or the like provides a trigger for autonomous operation. In another embodiment, a user action such as closing the lid or pressing a designated keyboard ‘hotkey’ triggers autonomous operation. In another embodiment, the mobile zero client 140 executes a timer function which triggers offline operation. In another embodiment, such as in digital signage applications, a loss of network connection provides a trigger for offline operation. At step 1240, the mobile zero client 140 prepares for autonomous operation by notifying the host computer 110 using, for example, an assigned status PMO. In some embodiments, such as select digital signage applications, the host computer transmits designated media to the client which is cached at step 1242 (“cache content”). The cached media may comprise a single display image or an image sequence transmitted as display image updates or the cached media may comprise a video and/or audio file communicated to mobile zero client 140 in compressed format over a virtual channel which is stored in memory 320. In other embodiments, the host computer 110 generates a blank display image (e.g. a black image) which is communicated to the mobile zero client 140. In an embodiment in which RCA 230 uses progressive encoding techniques, the image quality of the current source image is increased to a defined quality level but any changes to the source image are not transmitted. In other embodiments, the host computer continues to update the host frame buffer but updates to images are not communicated to the mobile zero client 140.

At step 1250 (“Autonomous Operation”), the mobile zero client 140 operates independently from host computer 110. In a digital signage embodiment, the mobile zero client 140 plays content stored at step 1220 or step 1242 using local processing resources such as ZC engine 312, CPU 314, GPU 316 and/or video codec 318. In another embodiment, the image sequence from a webcam device terminated at mobile zero client is displayed locally. In another embodiment, a client generated image such as a ‘pause’ icon is overlaid as a display image on the cached image received at step 1242 in response to a keyboard hotkey trigger. In another embodiment in which the lid is closes at step 1230, the client display sub-system is powered down and image sequence from the host computer 110 is suspended but RCA 230 continues to stream audio to an active client audio sub-system. In an embodiment in which a keyboard sequence or hotkey is used to change operation modes, the keyboard in terminated at mobile zero client 140 during autonomous operation. In some embodiments, transmission of host bound media such as video data from a client webcam and peripheral device data (e.g. USB data) are suspended. In an embodiment, an audio stream of the remote computing session is maintained but image updates of the remote computing session are suspended responsive to a changed lid status of the client computer or a detected delay in or absence of user interaction (e.g. as detected by a process of host computer 110 monitoring keyboard and/or mouse activity. In such an embodiment in which the lid is not closed or the mobile zero client 140 has no lid facilities (e.g. a tablet device), the host computer may reduce the display brightness or disable the backlighting of client 140. In the event of a predefined host application software event (e.g. a pop-up notification or an alert associated with a particular specified application), the host computer may send an audio alert to the mobile zero client 140, reinstate the display backlight and resumes image updates.

At step 1260 (“Mode Change?”), the mobile zero client 140 is prompted to switch operational modes again. In some cases, for example, following the power button being pressed or following a predefined delay period (e.g. 5 minutes), method 1200 proceeds to step 1262. Other mode change events such as presence detection, a client timer event or auto-resume process, keyboard hotkey, opening the lid and the likes prompt the method 1200 to proceed to step 1270 (“Trust?”) in which the trust relationship between client 140 and system 100 is determined. In some embodiments, step 1270 is bypassed and method 1200 proceeds to step 1220. If at step 1270, the trust has been invalidated (e.g. as determined by a client timer expiry, an instruction from connection manager 120, a change in GPS location from the time of authentication step 1210 or a detected prolonged absence), method 1200 returns to step 1210 in which authentication is required. If, at step 1270, the existing security context remains valid, method 1200 returns to step 1220 and host-interaction is resumed. In one such embodiment useful for digital signage and advertisement applications, application software executed at host computer 110 responds by updating the display image (e.g. transmitting a different display advertisement) each time the client iterates through step 1220, following which the client reverts to autonomous operation.

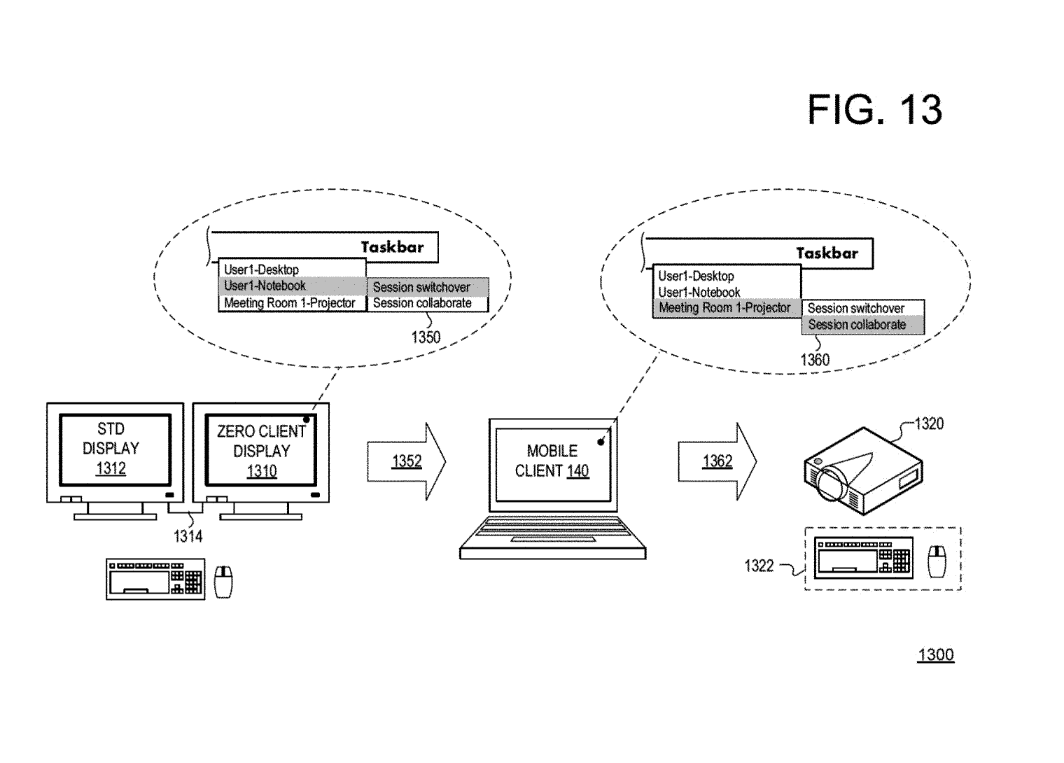

FIG. 13 depicts a handoff sequence 1300 used to provide seamless remote computing connectivity between a host computer 110 (ref. FIG. 1) and a user requiring desktop or application resources at any of several client devices such as a ZC display 1310, a mobile zero client 140 and a ZC projector 1320. At some point in time, a user establishes a secure remote computing session between a ZC display 1310 and the host computer 110. In an embodiment, the ZC display comprises a ZC processor 150 integrated with display circuitry known in the art such as support circuitry required for an LCD, LED or OLED display. In some such embodiments, ZC display 1310 comprises an industry-compliant port such as a VGA, DisplayPort or DVI port for connection of a second standardized display 1312 via cable 1314. In an embodiment, ZC display 1310 comprises high resolution (e.g. 1920×1080 pixels or greater) and large dimensions (e.g. 23 inches or larger) as might be for a workstation applied to Computer Aided Design (CAD) applications. It will be appreciated by those skilled in the art that in other embodiments, ZC display 1310 may comprise an alternative form factor such as a small footprint desktop device coupled to one or more displays. In further embodiments, ZC display 1310 is substituted with an alternative computing resource such as a workstation enabled with remote computing client software and NFC or Bluetooth capabilities for detecting the presence of mobile zero client 140.

At transition 1352, the ZC display 1310 detects the presence of mobile zero client 140 (e.g. as determined by NFC or Bluetooth proximity services of ZC display 1310 and corresponding facilities of mobile zero client 140) and the remote computing session is transitioned to mobile zero client 140. In an embodiment, the transition 1352 is orchestrated by the user in response to a visual prompt 1350 (e.g., a dialog box, drop down menu, or the like) presented by host computer 110 on the display 1310 or 1312.

At transition 1362, the mobile zero client 140 detects the presence of ZC projector 1320 (e.g. as determined by NFC or Bluetooth proximity services of mobile zero client 140 and corresponding facilities of ZC projector 1320, which, in an embodiment comprises instances of ZC processor 150 and wireless module 330) and the remote computing session is transitioned to ZC projector 1320, where after the projected session is controlled by keyboard and mouse 1322 associated with ZC projector 1320. In an embodiment, the transition 1362 is also orchestrated by the user in response to a visual prompt 1360 presented by host computer 110 on the display of mobile zero client 140. In another embodiment, transition 1362 comprises establishment of a concurrent collaboration session with ZC projector 1320 in which keyboard and mouse control is maintained by mobile zero client 140 but the display is mirrored or transitioned to ZC projector 1320.

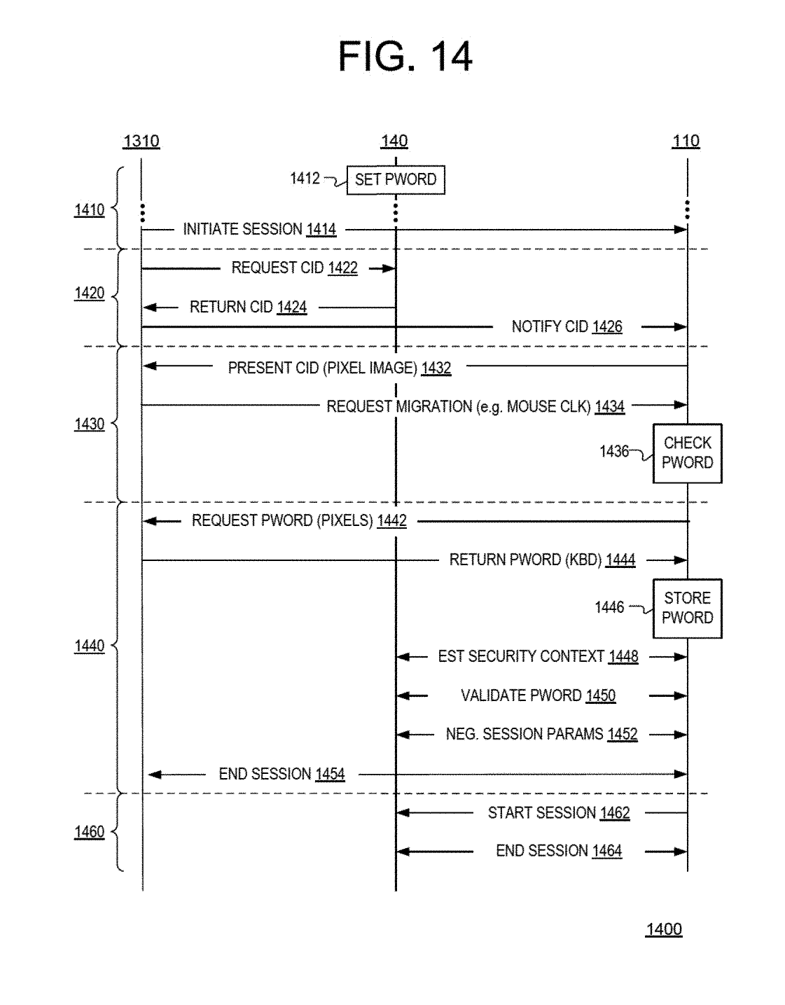

FIG. 14 shows a session handover process 1400 associated with transition 1352 of a remote computing session from a ZC display 1310 or comparable module to a mobile zero client 140. Process 1400 commences with a setup phase 1410 in which a password is configured for mobile zero client 140 at step 1412, typically either locally at mobile zero client 140 via a settings configuration menu or remotely using a browser interface. Setup phase 1410 is generally conducted during initial set up of ZC display 1310 and subsequently may be repeated in accordance with corporate security policies. Mobile zero client 140 may then be powered down for later use. At some future point in time, ZC display 1310 initiates a remote computing session with host computer 110, for example when power is applied to ZC display 1310, a host resource (i.e. host computer 110) is selected and corporate credentials are submitted either directly to host computer 110 or to a connection manager 120.

Process 1400 enters discovery phase 1420 when ZC display 1310 (already in session with host computer 110 following step 1414) detects the presence of mobile zero client 140. Such presence might be affirmed when mobile zero client 140 is brought within NFC or Bluetooth proximity of ZC display 1310 and the power is applied to the mobile ZC (e.g. when mobile ZC is placed on a desk approximately within a meter of ZC display 1310 and the lid is opened). When mobile zero client 140 is within communication range of ZC display 1310, ZC display 1310 requests a client identity (CID) at step 1422 such as a client IP address, a client Fully Qualified Domain Name (FQDN), a client Media Access Layer (MAC) address, a serial number or an alternative format of CID which can be resolved into a network address by a host computer 110 or a connection manager 120. At step 1424, the mobile zero client 140 engages local firmware to retrieve its identity information and returns its CID to the mobile zero client 140. In an embodiment without a connection manager, the ZC display 1310 notifies the host computer 110 of the detected presence by providing the host computer with the CID information received at step 1424. In an embodiment with a connection manager, the ZC display 1310 might notify the connection manager of the detected presence by providing it with the CID received at step 1424 and the connection manager forwards the notification to the host computer 110.

Process 1400 enters selection phase 1430 in which the user is notified of the detected presence, for example via a visual prompt 1350 such as a notification icon or dialog box rendered at host computer 110 which is then communicated to ZC display 1310 at step 1432 as an update to the display image (i.e. a set of compressed pixels). Such a dialog box presented at ZC display 1310 may comprise one or more of the following selection options related to the client identified by the CID i) Migrate the session to the client; ii) Ignore the client; iii) Always ignore the client; iv) Share a primary display with the client; v) Share a secondary display 1312 with the client; or vi) Migrate the secondary display 1312 to the client and maintain a session between the ZC display 1310 and host computer 110. At step 1434, the migration or collaboration (i.e. screen sharing) request is submitted to the host computer 110, typically in in the form of a mouse or keyboard interaction with the display image or a specified hotkey which is communicated to the host computer 110 as one or more USB events over the remote computing protocol 132.

At step 1436, host computer 110 retrieves a record associated with the CID received at step 1426 and determines whether a password related to the CID has previously been stored. If the host computer 110 does not a password on record, process 1400 proceeds to step 1442 of authentication phase 1440. If the host computer 110 does have a password on record, authentication phase 1510 of process 1500 is invoked. In an embodiment, host computer 110 maintains a list of ‘Favorite’ client devices which enables a user to tag a previously discovered client device for rapid future selection or automatic connection which may be useful for providing filtered client selection options in environment where multiple client devices are in close proximity.

At step 1442, host computer 110 requests a password associated with mobile zero client 140 for example via a dialog box rendered at host computer 110 which is then communicated to ZC display 1310 at step 1442 as another update to the display image. A password is entered and returned to host computer 110 at step 1444. In an alternative embodiment in which passwords are managed by the connection manager 120, the password may be submitted from the ZC display 1310 to the connection manager. At step 1446, the password is stored at host computer 110 (or connection management infrastructure, typically in encrypted form). At step 1448, host computer 110 initiates establishment of a security context such as an Secure Socket Layer (SSL) session between itself and the mobile zero client 140 which it uses to validate the password at step 1450 and negotiate remote computing session parameters (e.g. display topology and resolution, image and audio parameters), select an encryption method (e.g. Advanced Encryption Standard AES-256) and exchange encryption keys at step 1452. If the password is determined invalid at step 1450, step 1452 is not executed and the host computer 110 signals the ZC display 1310 accordingly.

At step 1454, the host computer 110 terminates the remote computing session with ZC display 1310 and initiates a new remote computing session (typically using a different set of encryption keys negotiated at step 1452) as a first step 1462 in the alternate remote computing session phase 1460. In an embodiment such as a collaboration environment in which concurrent sessions are active between the host computer 110 and multiple clients, step 1462 precedes step 1454. In an embodiment, the alternate remote computing session is terminated at step 1464, for example when the mobile zero client 140 is powered down or user absence is detected for a specified period from the mobile zero client 140. In some embodiments, the discovery phase 1420 is re-entered and the remote computing session is migrated back to ZC display 1310 when ZC display 1310 detects the proximity of the mobile zero client 140.

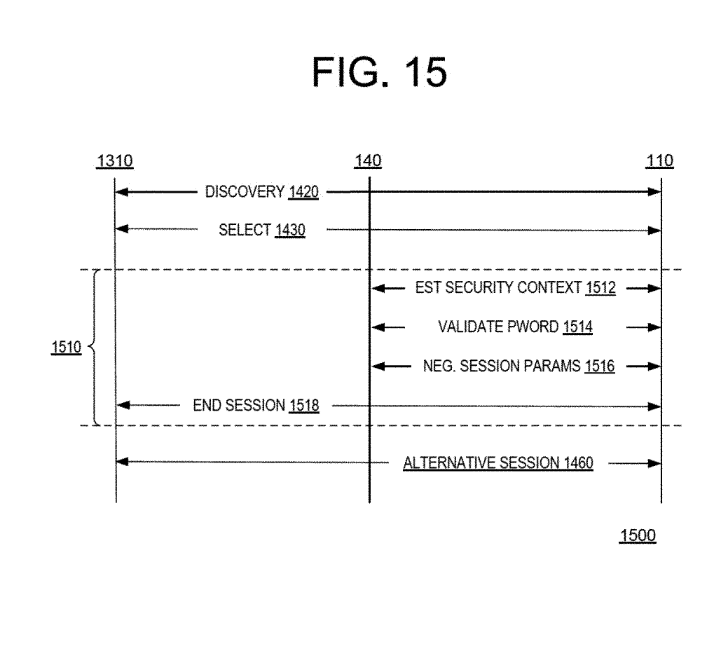

FIG. 15 shows a session handover process 1500 associated with transition 1352 of a remote computing session from a ZC display 1310 to a mobile zero client 140 in a select case in which the host computer 110 has a stored record of the password for mobile zero client 140. Authentication phase 1510 commences following step 1436 of phase 1430 where password availability is checked. The host computer 110 establishes a security context with the mobile zero client 140 at step 1512; validates the password on record at step 1514 and negotiates session parameters at step 1516 without prompting the ZC display 1310 for a password. The remote computing session with ZC display 1310 is terminated at step 1518 as for step 1454.

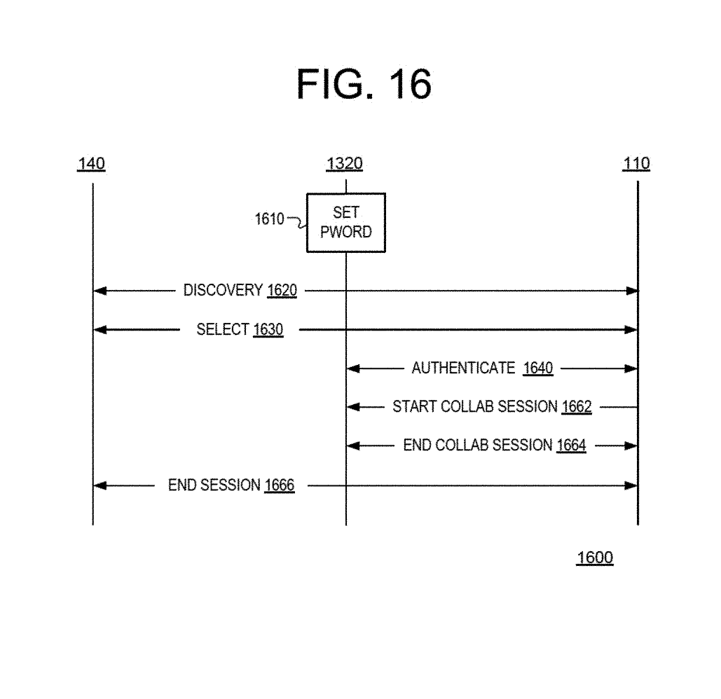

FIG. 16 shows a process 1600 associated with transition of a remote computing session between a host computer and a mobile zero client 140 to collaboration between the host computer 110 and multiple ZC devices, including ZC projector 1320.

At step 1610, a password is set for the ZC projector 1320, using for example a browser-based configuration interface. In different embodiments, the ZC projector 1320 might store different passwords for different users or a common password used by all users.

Discovery phases 1620 of process 1600 comprises CID exchange between mobile zero client 140 and ZC projector 1320 as described for discovery phases 1420. In some embodiments, a ZC projector 1320 may already be in session with a host computer that is invisible to host computer 110 at the time of discovery (i.e. an existing remote computing session between ZC projector 1320 and a host computer designated to a different user). In such an embodiment, the ZC projector 1320 might provide the mobile zero client 140 with host identity information which is passed by the mobile zero client 140 to the host computer 110 along with the CID for the ZC projector 1320. In other embodiments, a ZC projector 1320 may be in a reduced power sleep state when mobile ZC is brought in proximity. In some such cases, host computer 110 may be enabled to send a Wake on LAN (WoL) packet to the ZC projector 1320 based on a previously recorded IP address. If the ZC projector 1320 and the host computer 110 are on different network segments, the host may be enabled to send the wake/connect request to connection manager 120 which has access to the network segment used by ZC projector 1320. In other cases, the mobile zero client 140 is enabled to wake the ZC projector 1320 using a wireless-based wake facility such as Wake-on-WiFi or Wake on Bluetooth.

During selection phase 1630, the CID of the ZC projector 1320 is presented to the mobile zero client 140 with an option (e.g. menu dialog) enabling a user at mobile zero client 140 to transition or collaborate. Such a dialog box presented at mobile zero client 140 comprises at least one of the following selection options related to the ZC projector 1320: i) Migrate the session to the ZC projector 1320 (in which case the remote computing session between mobile zero client 140 and host computer 110 is generally terminated immediately; ii) Share a primary display with the ZC projector 1320 or iii) open a secondary display with the ZC projector 1320.

In some embodiments, the mobile zero client 140 is presented with a warning dialog if the ZC projector 1320 is in session with a different host. In some such embodiments, the host computer 110 provides an option to force relinquishment of the existing session. In other cases, the host computer 110 provides an option to request relinquishment of the existing session from the different host. In such a case, the ZC projector 1320 notifies the in-session host computer that another client is requesting a session transition by providing the in-session host with the CID of the mobile zero client 140. In some such embodiments, the in-session host provides the in-session client a display update comprising the CID of the mobile zero client 140 in conjunction with menu options to either ignore or honor the transition request. In other embodiments, the ZC projector 1320 uses a local display overlay to notify an in-session user of a collaboration request or session migration request.

During phase 1640, the host computer 110 is authenticated for use by ZC projector 1320 using a series of steps as described for phases 1440 and 1510. At step 1662, a second remote session between host computer 110 and ZC projector 1320 (i.e. a collaboration session) is initiated by host computer 110. ZC projector 1320 may force the delay of step 1662 until control by a different in-session host computer has been relinquished.

At step 1664, the collaboration session is terminated, for example in response to host computer 110 receiving a specified keyboard hotkey or under software menu control. In some such embodiments in which the entire remote computing session between mobile zero client 140 and host computer 110 was migrated to ZC projector 1320, the entire remote computing session is transitioned back to mobile zero client 140 in response to a hotkey or menu event. At step 1666, the remote computing session between host computer 110 and mobile zero client 140 is terminated.

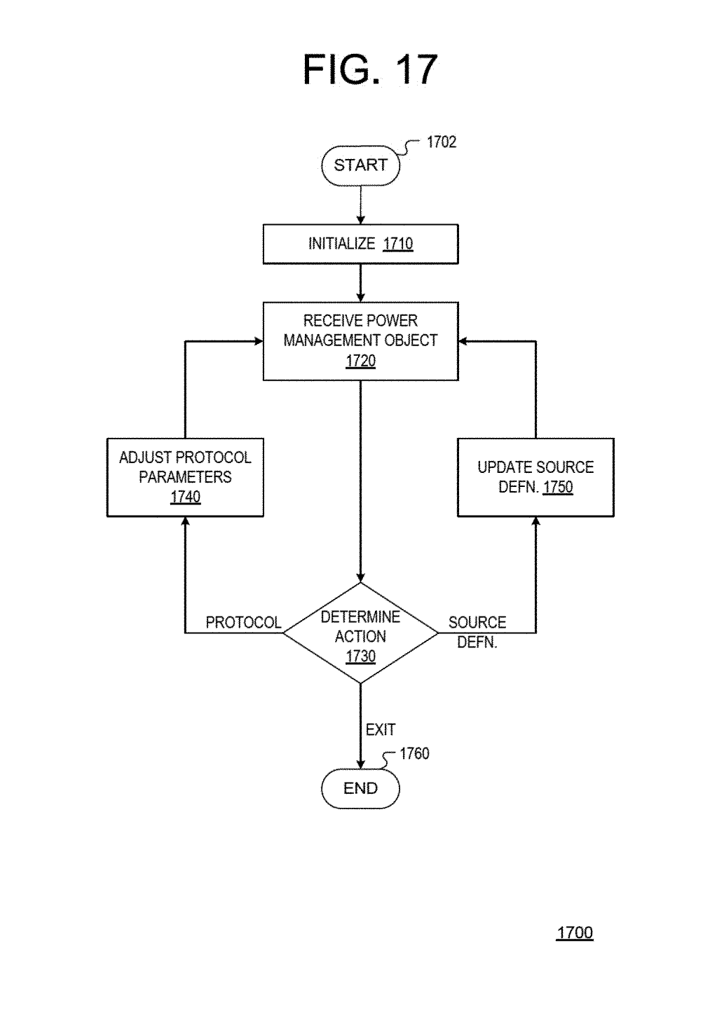

FIG. 17 illustrates a flow diagram for a method 1700 performed by a host computer 110 for adjusting protocol parameters or updating a source definition in response to a battery power management object 710 received from mobile zero client 140. Method 1700 starts at 1710 and proceeds to step 1710 (“Initialize”) in which an initial source definition (e.g. a default display resolution, default desktop source frame buffer and default audio source) and initial values for protocol parameters (e.g. a default frame rate of 30 frames per second) are selected. A remote computing session is established between the host computer 110 and the client 140.

Subsequently, method 1700 proceeds to step 1720 (“Receive Battery Power Management Object”) in which the host computer 110 receives a battery power management object 710 from the client 140 over, in one embodiment, a secure virtual channel associated with the remote computing session. In an embodiment, the battery power management object 710 comprises a remaining battery capacity value 716. In other embodiments, host computer 110 receives further power management objects such as one or more components of the power management object 154.

Method 1700 proceeds to step 1730 (“Determine Action”) in which the host computer 110 determines a power management action based on the battery power management object received at step 1720. In an embodiment, power management actions comprise a set of rules applied to remote computing agent 230 based on user- or administrator-defined power management objectives. For example a constraint on the maximum frame rate (i.e. the minimum frame update period) may be enforced after a remaining battery threshold limit is crossed. Such a threshold may be configured by application software at host computer 110 or communicated from client 14 or set using configuration software such as connection manager 120 and communicated from the server 124 to the host computer 110. Another example is a power management rule that defines an alternative source definition based on the state of presence object 750.

If, at step 1730, it is determined that a protocol action is required, method 1700 proceeds to step 1740 in which one or more protocol parameters associated with the remote computing session are adjusted. In an embodiment, an image update period is specified for the remote computing session that is in proportion to the remaining battery capacity value 716. In another embodiment, the parameter comprises a codec selection parameter utilized to switch from a decomposition-based encoder or an advanced video coding (AVC) encoder when the remaining battery capacity value 716 crosses a specified threshold. In another embodiment, the at least one parameter comprises a changed image brightness for the display image of the remote computing session. Method 1700 proceeds from step 1740 to step 1720.

If at step 1730, it is determined that a source redefinition is required, method 1700 proceeds to step 1750 (“Update Source Definition”). In an embodiment, the display resolution is adjusted in response to the remaining battery capacity value 716 crossing a specified threshold. In another embodiment, image updates of the remote computing session are suspended responsive to one of i) a changed lid state 762 computer or ii) a detected delay in user interaction with the client but an audio stream of the remote computing session is maintained. In such an embodiment, the host computer 110 sends an audio alert to the client 140 and resumes the image updates in response to defined host application software events such as pop-up notification dialogs. Method 1700 proceeds from step 1750 to step 1720 where additional power management objects may be received. The method then proceeds to step 1730. If at step 1730, an event such as a disconnection request is detected, method 1700 ends at step 1760.

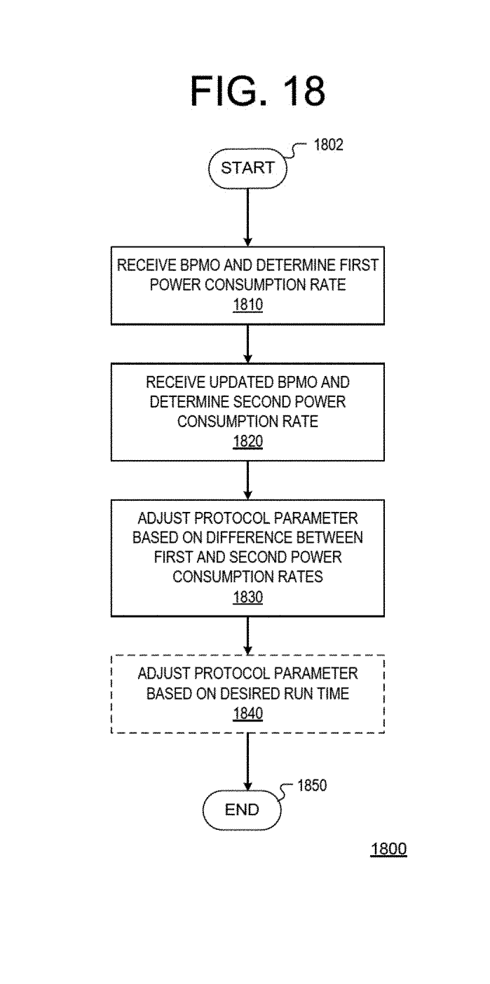

FIG. 18 illustrates a flow diagram for a method 1800 performed by a host computer 110 for adjusting a protocol parameter based on power consumption dynamics. Method 1800 starts at step 1802 and proceeds to step 1810 (“Receive Battery Power Management Object (BPMO) and Determine First Power Consumption Rate”). In an embodiment, the first power consumption rate for client 140 is determined by periodically evaluating remaining capacity 716 or estimated run time 717 and calculating the power consumption rate based on the evaluation period and battery specifications for client 140 (i.e. a milliwatt hour mW-h specification). Method 1800 proceeds to step 1820 (“Receive Updated Battery Power Management Object (BPMO) and Determine Second Power Consumption Rate”) in which a second power consumption rate for client 140 is determined by re-evaluating the remaining capacity 716 or estimated run time 717 following a second evaluation period and recalculating the power consumption rate based on the second evaluation period. Method 1800 proceeds to step 1830 (“Adjust Protocol Parameter based on Difference Between First and Second Power Consumption Rates”) in which a protocol parameter such as the minimum image update period is regulated based on the change in power consumption. For example, if the second power consumption rate is determined as higher than the first power consumption rate, the minimum image update period is increased which effectively reduces the maximum frame rate for the remote computing session. Method 1800 proceeds to optional step 1840 (“Adjust Protocol Parameter based on Desired Run Time) in which protocol parameters, such as the minimum image update period, are further adjusted based on a specified battery run time such as a user or administrator defined total battery run time related to the total battery capacity or a user-defined remaining battery run time related to the capacity of a partially discharged battery. Method 1800 ends at step 1850. In an embodiment, a request is submitted to extend the remaining battery run time and the remote computing protocol is adjusted accordingly.

While the foregoing is directed to embodiments of the present invention, other and further embodiments of the invention may be devised without departing from the basic scope thereof, and the scope thereof is determined by the claims that follow.

1. A method for managing power consumption of a client computer, comprising:
receiving, by a host computer from the client computer, a battery power management object (“BPMO”) related to a remote computing session, the host computer communicatively coupled to the client computer by the remote computing session;
determining, by the host computer and from the BPMO, at least one power management action for the remote computing session; and
adjusting, by the host computer and in accordance with the at least one power management action, a minimum image update period for the remote computing session, wherein the minimum image update period is adjusted proportionally to a level of user interactivity weighted by a remaining battery capacity of the client computer specified in the BPMO, and wherein the minimum image update period maintains a non-zero frame-rate of the remote computing session.

2. The method of claim 1 wherein the BPMO is received by the host computer via a virtual communications channel established between the host computer and the client computer, wherein the virtual communications channel is within a security context defined for the remote computing session.

3. (canceled)

4. The method of claim 1 wherein the minimum image update period is specified when a battery capacity value of the client computer falls below a specified threshold and wherein the BPMO comprises at least the battery capacity value.

5. The method of claim 4 wherein the specified threshold is set by application software on the host computer or received from one of the client computer or a connection manager.

6. The method of claim 1 wherein the at least one power management action is further determined according to an increased pixel decimation for image content.

7. The method of claim 1 wherein the at least one power management action is further determined according to a codec selection parameter, the codec selection parameter utilized to invoke one of a decomposition-based encoder or an advanced video coding (AVC) encoder.

8. The method of claim 1 wherein the at least one power management action is further determined according to a changed image brightness for an image displayed on a display of the client computer.

9. The method of claim 1 wherein the at least one power management action is further determined according to a reduced audio parameter.

10. The method of claim 20 wherein the source definition specifies a display resolution and wherein adjusting the source definition comprises reducing the display resolution.

11. The method of claim 1 further comprising maintaining an audio stream of the remote computing session but suspending image updates of the remote computing session responsive to one of i) a changed lid status of the client computer or ii) a detected delay in user interaction with the client computer.

12. The method of claim 11 further comprising the host computer sending an audio alert to the client computer and resuming the image updates in response to a host application software event.

13. The method of claim 2 further comprising suspending image updates of the remote computing session but maintaining the security context of the remote computing session responsive to a changed presence status at the client computer.

14. The method of claim 13, further comprising terminating the remote computing session following a specified period of detected user absence.

15. The method claim 20 wherein adjusting the source definition comprises adjusting image translation applied to a source image communicated by the remote computing session, wherein the image translation specifies at least one of i) a chroma adjustment of the source image, ii) a spatial resolution adjustment of select portions of the source image or iii) an update rate adjustment for select portions of the source image.

16. The method of claim 20 wherein adjusting the source definition comprises adjusting operating system visual effects applied to a source image communicated by remote computing session.

17. The method of claim 1 further comprising:
receiving an updated BPMO and determining a second power management action, wherein the BPMO and the updated BPMO are indicative, respectively of a first power consumption rate and a second power consumption rate and wherein the second power management action is based on a difference between the first power consumption rate and the second power consumption rate.

18. The method of claim 17 wherein the second power management action is further based on a specified battery run time.

19. An apparatus for power management of a zero client computer comprising:
a host computer communicatively coupled to the client computer via a remote computing session wherein the host computer:
receives and monitors a battery power management object (BPMO) from the client computer;
determines from the BPMO at least one power management action for the remote computing session;
and adjusts a minimum image update period of the remote computing session in accordance with the at least one power management action, wherein the minimum image update period is adjusted proportionally to a level of user interactivity weighted by a remaining battery capacity of the client computer specified in the BPMO, and wherein the minimum image update period maintains a non-zero frame-rate of the remote computing session.

20. The method of claim 1, further comprising:
adjusting a source definition of the remote computing session according to the at least one power management action.
